(19) United States
(12) Patent Application Publication
(10) Pub. No.: US 2003/0154092 A1
(43) Pub. Date: Aug. 14, 2003

(54) Method and system for behavioural simulation of a plurality of consumers, by multiagent simulation

(76) Inventors: Thierry Bouron, Conflans Ste Honorine (FR); Lamjed Ben Said, Lannion (FR)

Correspondence Address: PATENT DOCKET DEPARTMENT, GARDNER CARTON & DOUGLAS LLC, 191 N. WACKER DRIVE, SUITE 3700, CHICAGO, IL, 60606, US

(21) Appl. No.: 10/276,639

(22) PCT Filed: May 16, 2001
(86) PCT No.: PCT/FR01/01491

(30) Foreign Application Priority Data
May 19, 2000 (FR) 00/06479

(51) Int. Cl. G06F 17/60

(52) U.S. Cl. 705/1; 705/10; 705/14

(57) ABSTRACT

The invention concerns a method and a system for behavioral simulation of consumers in a virtual market (MV). It consists in: setting up (A) a consumer agent behavioral model (MCCⱼ) for each consumer based on behavioral primitives (PC_{j,n}) and setting up (B) a supplier agent behavioral model (MCFₖ) for each supplier based on behavioral primitives (PC_{k,n}). The supplier behavioral primitives (PC_{k,n}) enable to generate stimuli (Sₖ) or factual (Fᵣ) variables addressed to each consumer agent behavioral model (MCCⱼ) which deliver, from decisional variables (D_{j,k}) , dedicated decisional variables (DD_{j,k}) in the context of the virtual market. The dedicated decisional variables (DD_{j,k}) are represented (C) in the form of behavioral trends. The invention is applicable to all types of market research.

The present intention relates to a method and a system for behavioral simulation of a plurality of consumers, in a competitive market, by multi-agent simulation.

In the area of social or cognitive sciences, the purpose of multi-agent simulation methods is to specify and validate the behavioral models of individuals of a population that it is believed might be the source of organization or social phenomena.

Up to the present time, several works have shown the advantage of multi-agent simulation, in the area of social sciences, cf., in particular, the publication by HANNEMAN R. and PATRICK S. entitled “On the Uses of Computer-Assisted Simulation Modeling in the Social Sciences”, Sociological Research Online, Vol 2, N^{o}2, http://www.socresonline.org.uk/socresonline/2/2/25.html.

This type of simulation appears more particularly appropriate in situations in which the contribution of behavior of individuals to global behavior cannot be explained deductively.

In particular, it appears that the evolution of consumers, or of groups of consumers, can prove to be an explanatory factor in the emergence of certain social and/or economic phenomena.

Up until the present time, few studies or developments have been interested in the multi-agent simulation process as a tool for studying the evolution of the behavior of consumers in an environment of competitive commercial offers. In fact, the complexity of this behavior and the difficulty in formalizing it make the methods based on numerical analysis inadequate for observing the effects of interactions between individuals over a significant period of time.

Referring to the article entitled “Agent based computing, a booklet for Executives, EURESCOM, p.712 and p.815 www.eurescom.de, it appears that multi-agent systems are principally used in two large areas of application: the distributed solution of problems and the design of systems in open environments.

Furthermore, simulation constitutes a third and more recent area of application where the multi-agent approach makes it possible to study complex systems, such as socio-economic phenomena. Simulation constitutes an alternative to the stochastic approaches more conventionally used in this context.

With regard to the aforesaid stochastic approaches, the behavior of individuals is assumed to be caused by objectives, motivations and intentions. It is generated on the basis of inference mechanisms and probability calculations.

Several studies have proposed economic and behavioral models of the various participants in the market. These models are used for establishing predictions. In an article published by Frank M. BASS entitled “The Theory of Stochastic Preference and Brand Switching”, Journal of Marketing Research, Vol. XI, February 1974 1-20, the reader's attention is drawn to the importance of the random nature of consumer behavior. A stochastic model is proposed for explaining certain factors which determine consumer choices in a competitive market. The use of Bayesian statistics is one of the approaches most widely used in market research studies regarding the analysis of consumer behavior.

An example is given in the study carried out and published by Rajiv GROVER and V. SRINIVASAN entitled “Evaluating the multiple effects of Retail promotions on Brand Loyal and Brand Switching Segments”, Journal of Marketing Research, February 1992, 76-89. This study analyzes the effects of promotions as a function of the loyalty of the clientele to a commercial brand. The segmentation of consumers, that is to say their subdivision into specific behavioral groups, was determined by an iterative Bayesian procedure.

In a similar context, the works of Carl F. MELA, Sunil GUPTA and Donald R. LEHMANN “The Long-Term Impact of Promotion and Advertising on Consumer Brand Choice”, Journal of Marketing Research, May 1997, 248-261 and of Purushottam PAPATLA, Lakshman KRISHNAMURTHI, “Measuring the Dynamic Effects of Promotions on Brand Choice”, Journal of Marketing Research, February 1996, 20-36, studied the long-term impact and the dynamic effects of promotion of the choice of a brand in a competitive market. These works apply a statistical analysis approach to real data bases in order to construct prediction models.

The aforesaid stochastic approaches in fact focus on a specified level of analysis.

However, in the study of socio-economic phenomena, it can be advantageous to make modeled behavior correspond at the individual level, the micro level, to global variables measured at group level, the macro level.

The probabilities or stochastic approaches do not allow the study of such correlations. By way of example, it is recalled that an analysis based on the stochastic approach of the evolution of the unemployment rate makes use only of macro-economic variables or parameters such as the rate of inflation and the rate of economic growth, whilst the decision making of individuals, such as the refusal of precarious jobs by job applicants, have an important function in determining the overall rate of unemployment. Furthermore, the stochastic approaches do not take into consideration the interactions between individuals. In other words, the models resulting from these approaches take very little account of collective phenomena and of certain modifications of the environment generated by these interactions.

Multi-agent simulation provides an answer adapted to the aforementioned limitations. It essentially consists in constructing artificial or virtual societies of software agents representative of individuals and groups of individuals or simulated populations. The software agents interact in a concomitant manner. These interactions make it possible to represent actions and effects of retroactions that are the source of modifications of the virtual environment in which the agents evolve.

Furthermore, the modeling of the behavior of individuals by the intermediary of these software agents, several characteristics of these individuals such as behavior, abilities and relational links being able to be modeled, makes it possible, due to a multi-agent approach, to take into account the non-linear effects of these interactions between the various individuals and/or agents of the modeled virtual environment.

Finally, multi-agent simulation makes it possible to preserve the heterogeneity of the system to be simulated, the progress of artificial intelligence techniques linked with the progress in the computing power of processors allowing, at the present time, the handling of a large number of agents with the most varied characteristics.

More particularly, the use of multi-agent simulation processes in a socioeconomic context has been the subject of several work projects or developments.

Among these it is possible to mention, in particular:

The economic model project published by N. BASU, R. J. PRYOR, T.QUINT and T. Arnold ASPEN entitled “A microsimulation model of the economy”, SANDIA REPORT SAND96-2459 UC 905, October 1996, relates to a simulation of the economy of the Unites States and uses more than one thousand agents which represent the different economic participants such as banks, businesses, the stock exchange and households.

The development entitled “Consumats in a commons dimemma: Testing the behavioural rules of simulated consumers” published on-line by W. JAGER, M. A. JANSSEN, C. A. J. VLEK at the HTML address: http://www.ppsw.rug.nl/cov/staff/jager/simpaper.pdf describes a simulation of a behavioral model of the consumer in the context of shared resources management. This simulation studies in particular the effects of satisfaction and uncertainty on harvesting behavior among individual consumers. It is recalled that harvesting behavior can be compared with the habit of hoarding. However, the described development is poorly adapted to the observation of organization phenomena insofar as the number of agents used is restricted, of the order of twenty.

The development published on-line, 1995, by E. L. BRANNON, P. V. ULRICH, I. J. ANDERSON, T. MARSHALL (Auburn), A. DONALDSON (NCSU) Research Associates: S.THOMMESEN and N. TERASE (Auburn) at the HTML address: http://www.humsci.auburn.edu/ca/html/branntc.html entitled “Artificial Life Simulation of the Textile/Apparel Marketplace: An Innovative Approach to the Strategizing about Evolving Markets” describes two multi-agent simulator systems produced for the purpose of studying the spread of clothing fashion innovation in a population and the influence of interactions between suppliers and consumers on the structuring of the textile market.

More recently, the patent U.S. Pat. No. 5,949,045 was granted on Sep. 7, 1999. This patent covers and describes a method and a system for simulating electronic payment transactions wherein the behavior of software agents, simulating the consumer individuals, on the basis of the type of agent and by probability, for the type in question, makes it possible to carry out one or more transactions. The definition of the behavior of each agent is carried out by a specific description, by the entry of specific parameters, and constitutes an ad hoc definition. Such an approach therefore amounts to the stochastic approach previously mentioned in the description, insofar as the probability of completing transactions remains the pertinent parameter for each simulated software agent. For this reason, such a system does not make it possible to fully take into account the correlations at global level of the individual variables determining each software agent, insofar as such variables must, with reference to the probability principle used, be considered as substantially independent, from one agent to another.

The purpose of the present invention is to overcome the disadvantages and limitations inherent in multi-agent simulation methods and systems of the prior art.

In particular, the present invention relates to the use of a method and system for multi-agent behavioral simulation allowing the application of these simulations in the context of a competitive market for high-technology products or services, such as those relating to telecommunications.

The present invention also relates to the use, in the aforementioned context, of a consumer agent behavioral model, such a model defining elementary rules of behavior allowing the simulation of a population of individuals, of consumers, of at least a thousand, for conventional data processing means, normally available in commerce.

The present invention also relates to the use, in the aforementioned context, of a supplier agent behavioral model, such a model in particular defining rules of behavior, that is to say rules of economic or commercial action, of each supplier agent, in the aforementioned context, with respect to each consumer agent.

The present invention consequently also relates to the use of a dynamic model, taking into account the various interactions of consumer agents and supplier agents.

The present invention also relates to the use, in the context of an aforementioned competitive market, and the revealing, in the context of this competitive market, modeled in the form of a virtual market, of emergent phenomena representative of one or more behavioral tendencies for at least one consumer or a group of consumers in the context of this virtual market.

Finally, the present invention also relates to the use of a method and of a multi-agent behavioral simulation system making it possible to study and reveal the characteristic values of each individual and the emergent phenomena such as the segmentation of the population into population groups depending on the behavioral attitudes of the latter.

The method for behavioral simulation of a plurality of consumers, according to the present invention, is noteworthy in that it comprises the steps consisting in establishing, for each consumer or group of consumers, a consumer agent behavioral model, on the basis of a plurality of consumer behavioral primitives, these consumer behavioral primitives making it possible, on the basis of stimuli variables and depending on the internal value of the consumer behavioral primitives, to establish, for each consumer or group of consumers, a plurality of decisional variables in the context of this virtual market, and, for each supplier, a supplier agent behavioral model on the basis of a plurality of supplier behavioral primitives in the context of this virtual market. The supplier behavioral primitives make it possible, on the basis of specific data on the virtual market, to generate a plurality of stimuli variables addressed to all of the consumer agent behavioral models, which makes it possible to obtain a set of dedicated decisional variables representative of an opinion of each consumer agent behavioral model in the context of this virtual market. The dedicated decisional variables are represented, at least literally, in the context of the virtual market, in the form of emergent phenomena, representative of one or more behavioral tendencies for a plurality of consumer agents in the context of this virtual market.

The method and the system for behavioral simulation of a plurality of consumers, by multi-agent simulation, to which the present invention relates, will be better understood on reading the description and observing the drawings hereafter wherein:

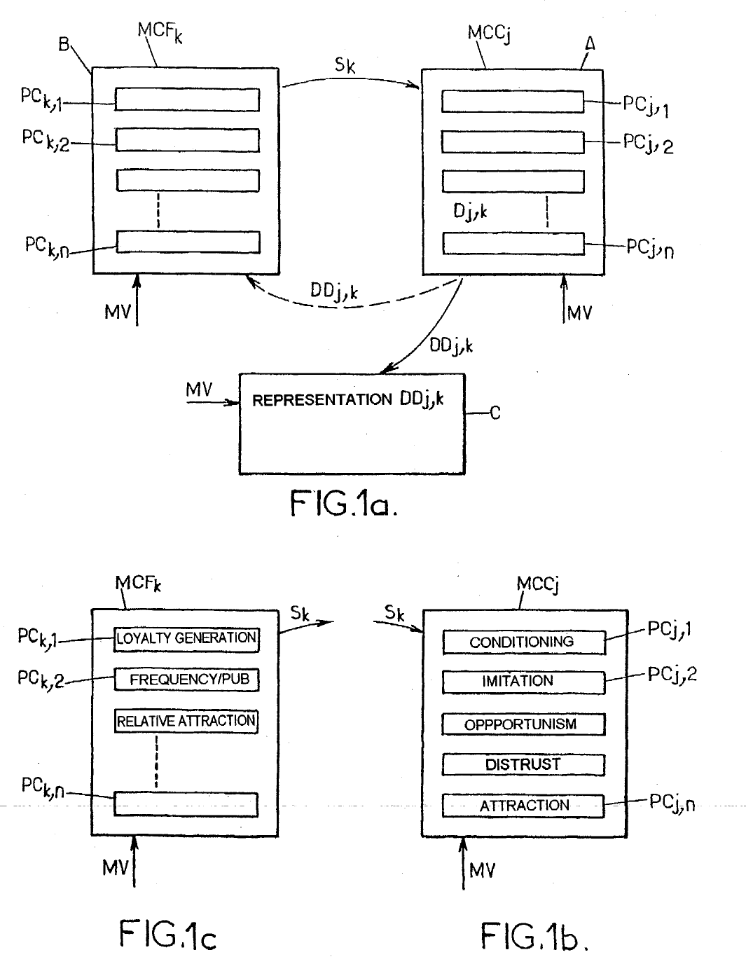

FIG. 1a shows, in block diagram form, a flowchart illustrating the behavioral simulation method for a plurality of consumers, by multi-agent simulation, according to the invention;

FIG. 1b and 1c show, by way of non-limitative example, a detail of the use of a consumer agent behavioral model and of a supplier agent behavioral model respectively;

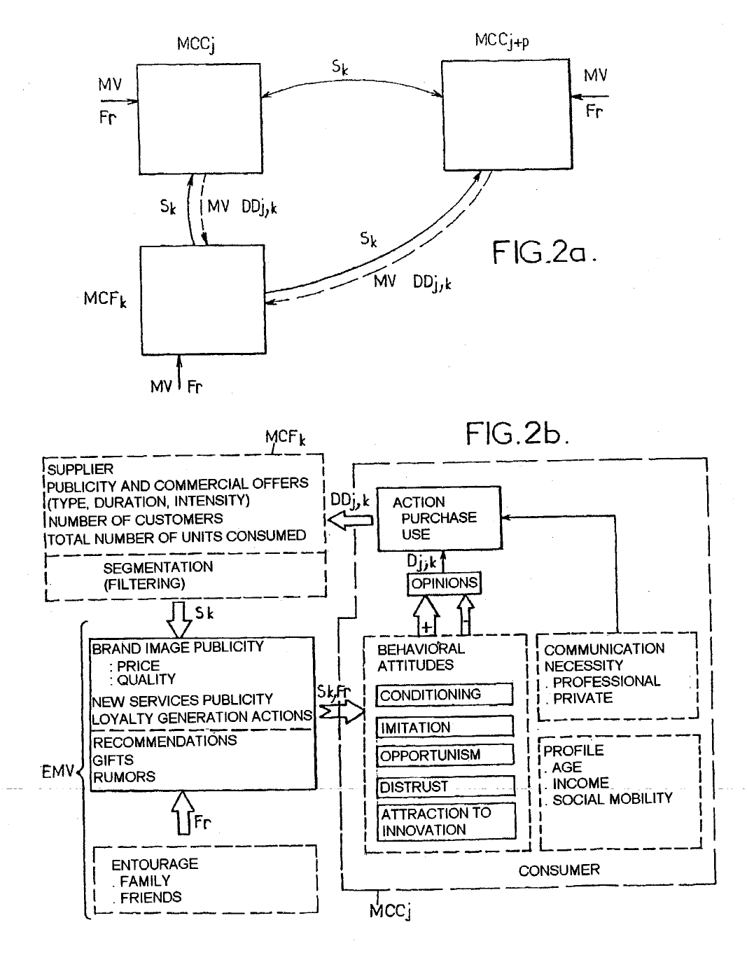

FIG. 2a shows, in the form of a functional diagram, the interactions taking place, in the simulation method according to the present invention, between the participants in the simulation model, namely the consumer agent behavioral model, the supplier agent behavioral model and, of course, the virtual market, the environment for using the simulation method according to the present invention;

FIG. 2b shows, more specifically, the interactions between a consumer agent behavioral model, a supplier agent behavioral model and the virtual market;

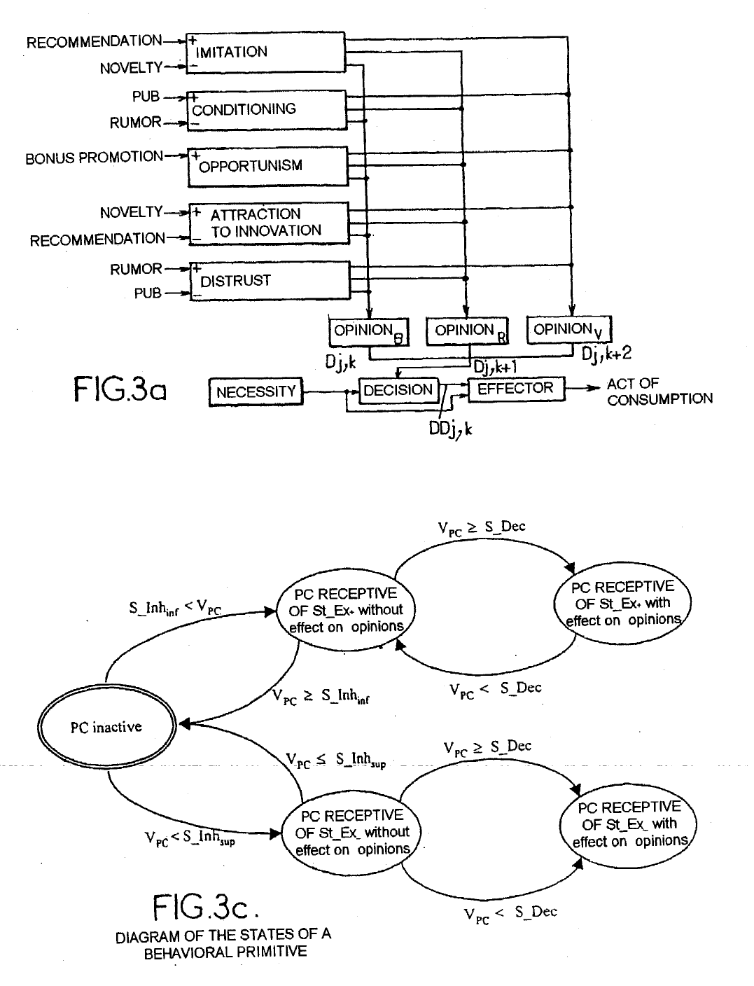

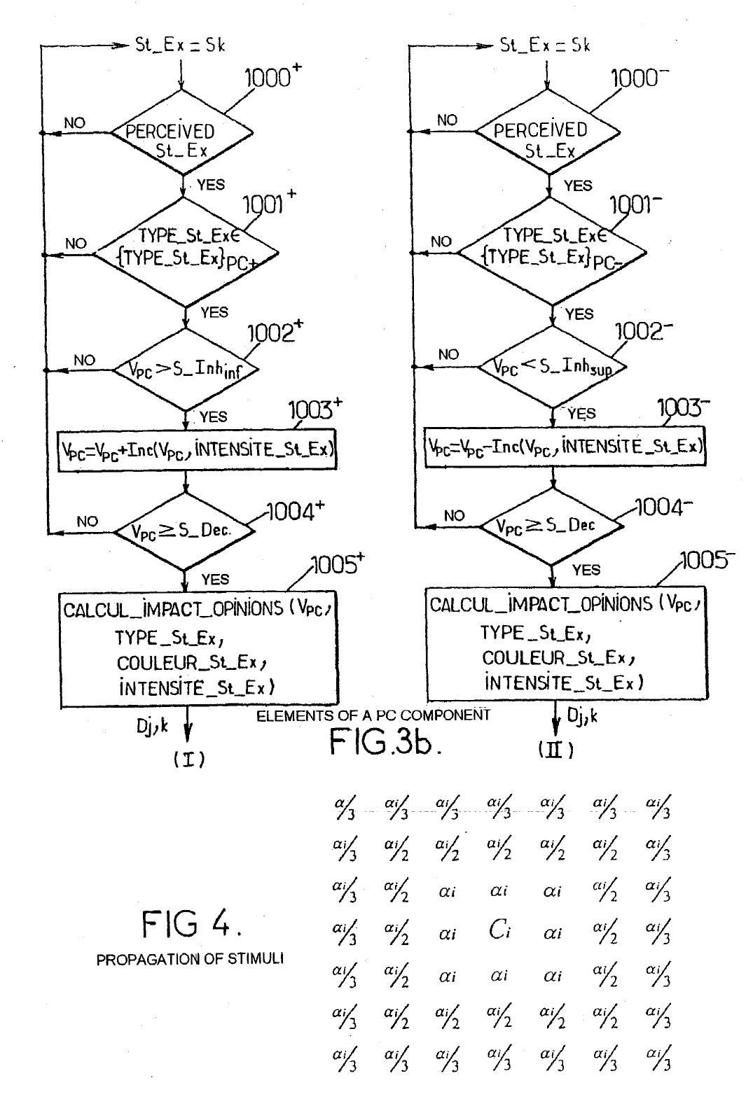

FIG. 3a shows, by way of non-limitative example, the arrangement and the interconnection of specific behavioral primitives allowing the use of each consumer agent behavioral model;

FIG. 3b shows, by way of illustration, the non-linear transfer function of each behavioral primitive with respect to environmental variables of the virtual market such as factual variables or stimuli variables, generated by any consumer agent or supplier agent behavioral model and that of the environment;

FIG. 3c shows a status diagram of a behavioral primitive whose transfer function is shown in FIG. 3b;

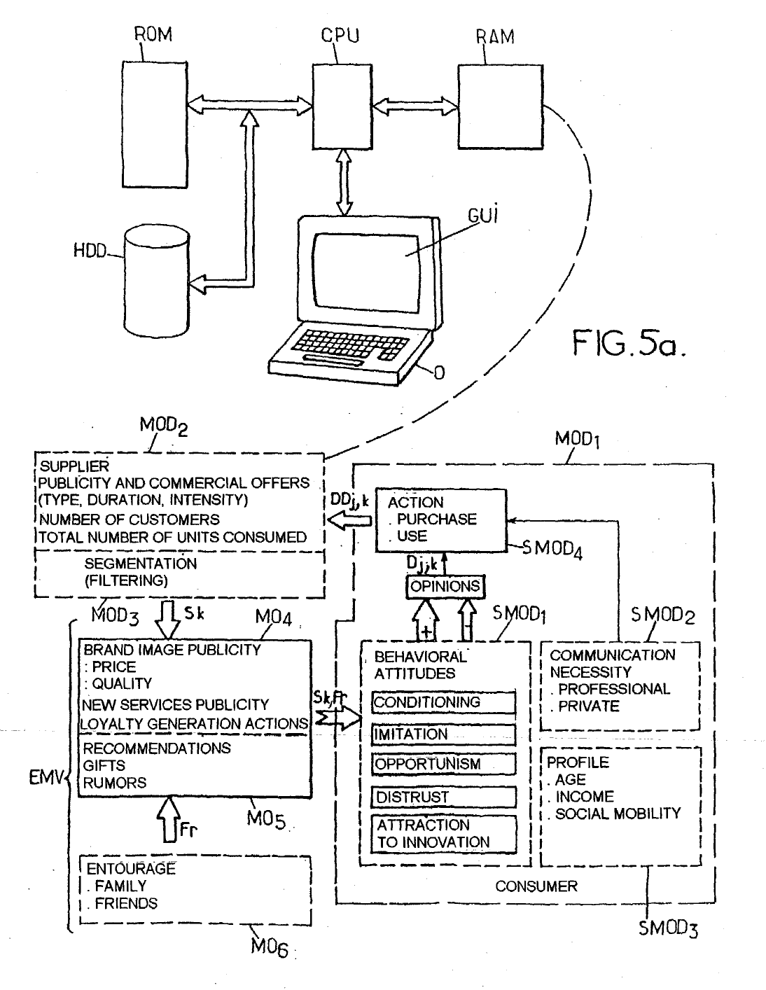

FIG. 4 gives a representation of an area of influence allocated to any current consumer agent behavioral model with respect to any neighboring consumer agent behavioral model, in all of the consumer agent behavioral models constituting a representation of a population of consumers;

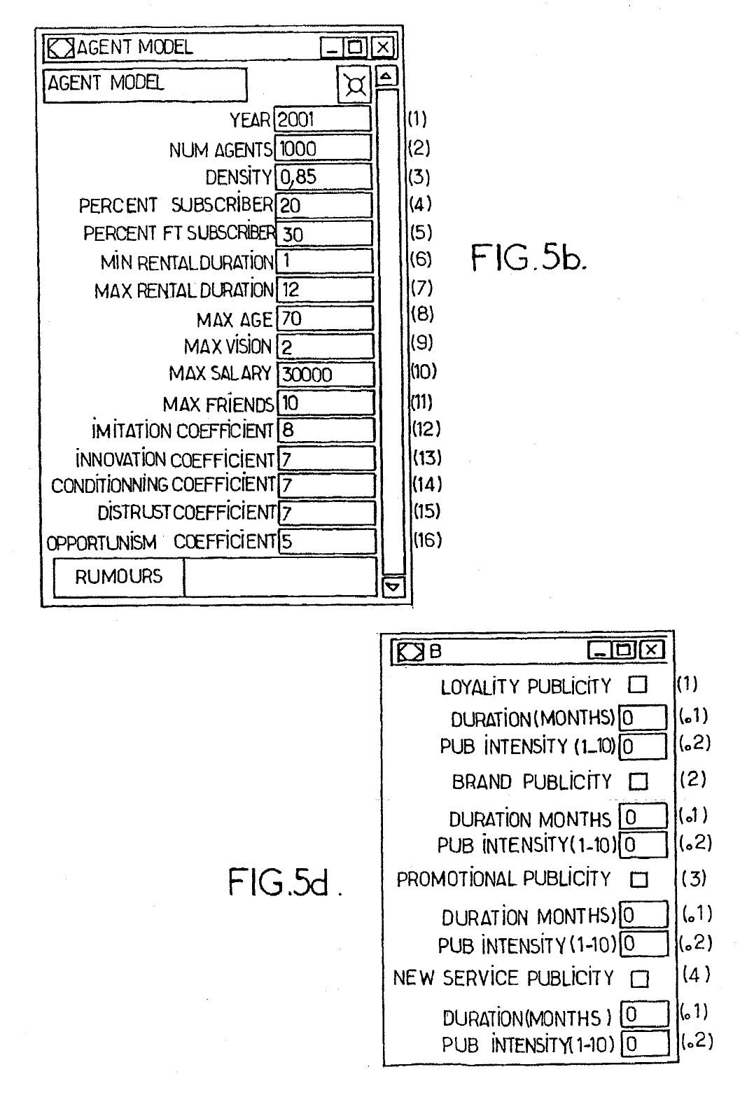

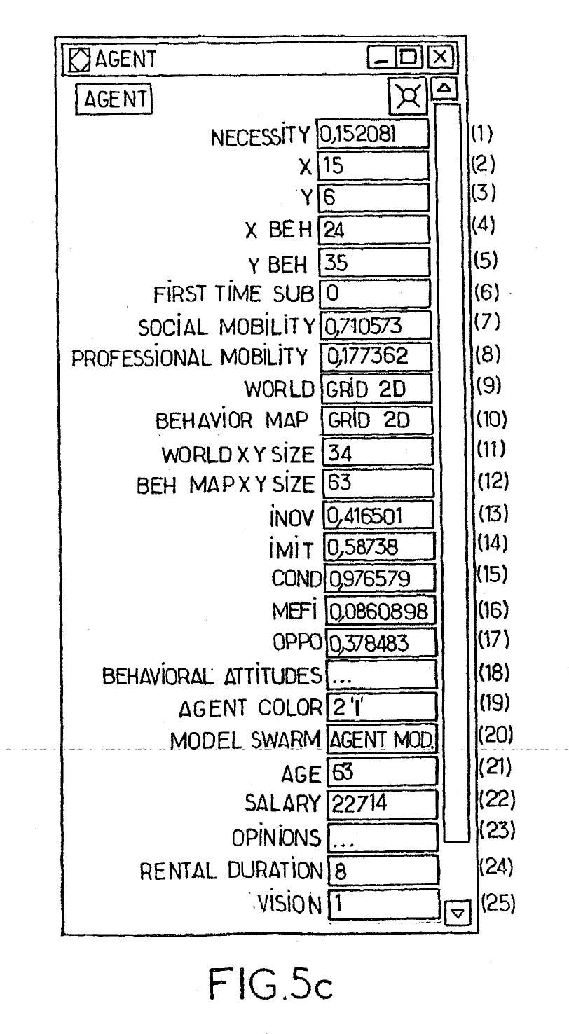

FIG. 5a shows, by way of illustration, the architecture of a behavioral simulation system for a plurality of consumers, by multi-agent simulation, according to the present invention;

FIGS. 5b, 5c and 5d, show different screen pages for the entry and display of parameters making it possible to initialize and configure the supplier agent and consumer agent behavioral models respectively;

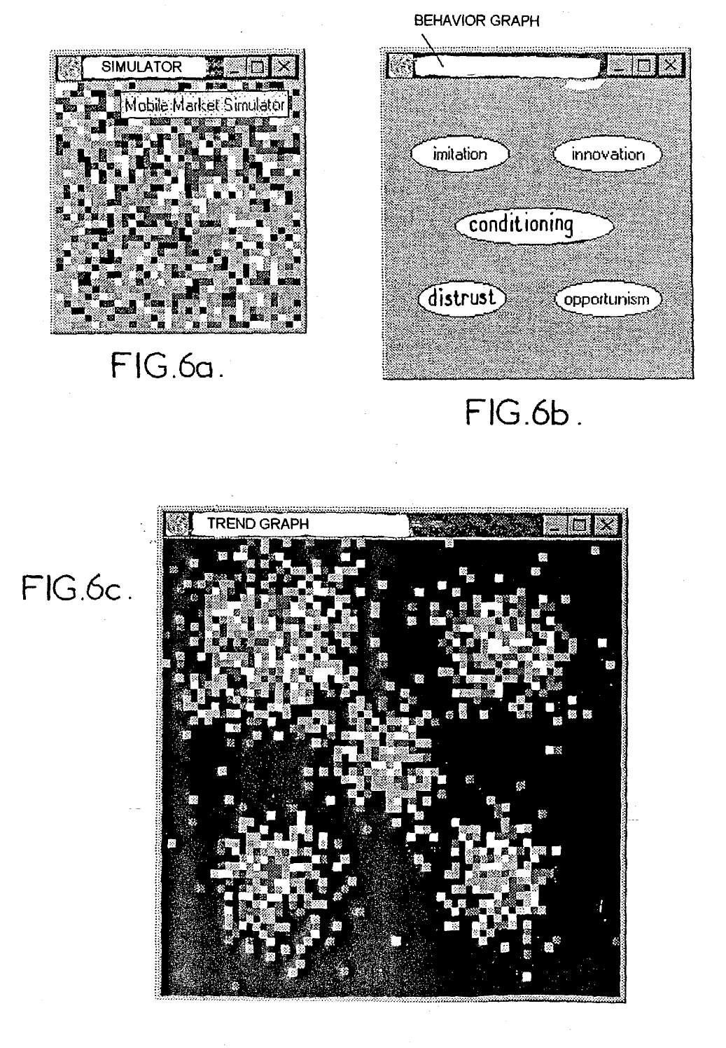

FIGS. 6a, 6b and 6c show, in an illustrative and non-limitative way, a preferred process of representation, by graphical display, of dedicated decisional variables in the context of a virtual market, in the form of emergent phenomena representative of one or more behavioral tendencies;

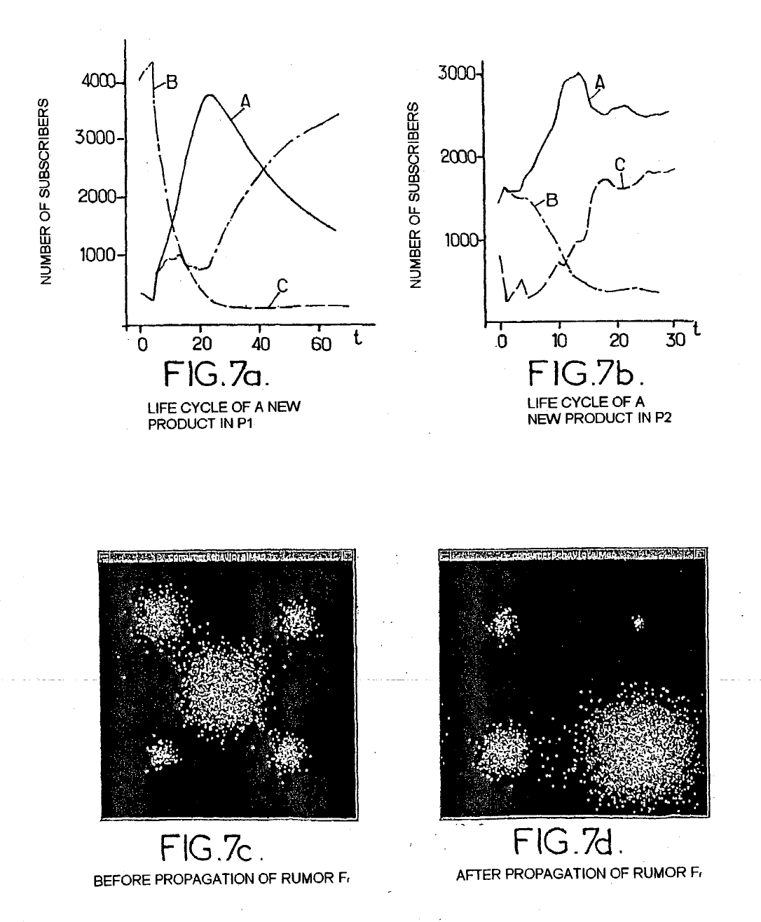

FIGS. 7a and 7b show, by way of illustration, results of simulation of a life cycle of a new product in a first population in which the consumer individuals have a coefficient of innovation respectively higher and lower than the imitation coefficient;

FIGS. 7c and 7d shows a representation of a consumer behavioral distribution respectively before and after activation and propagation of a rumor, factual variable F, in a multi-agent behavioral simulation system according to the present invention.

A more detailed description of the method for behavioral simulation of a plurality of consumers, by multi-agent simulation, according to the present invention, will now be given with reference to FIGS. 1a to 1c and to the following figures.

In general terms, it is pointed out that the behavioral simulation method according to the invention is used in the context of a virtual market, referenced MV, which, of course, is constituted by a modeling of a real market.

It is considered in particular that the modeling of the real market constitutes a first step of implementation, this step consisting, in order to constitute the virtual market MV, in extracting pertinent characteristics of attitudes related to consumption for potential consumers on the basis of surveys and analyses of the area of application in the real market in question. The term “consumer” is understood to mean, in the context of the description of the present patent application, any physical or legal person or, if applicable, any group of physical or legal persons, such as for example the family unit constituting a consuming household, representative of a virtual population in this virtual market.

In a non-limitative way, it is pointed out that the description of the method and the system for behavioral simulation according to the invention will be given hereafter in the context of the mobile telephony market, that is to say a market for products with very high added value. It is thus understood that the aforementioned use makes it possible to construct an abstract and simplified model which takes account of the pertinent characteristics of the real market. The definition of the behavior of customers and, of course, the modeling of this behavior by software agents known as consumer agents, must exhibit a compromise between simplicity and realism, in order to allow, in particular, the introduction of a sufficiently large number of agents and to represent the emergent phenomena revealed at the level of a set of agents representative of a population.

As shown in FIG. 1a, it is pointed out that the behavioral simulation method according to the present invention consists, for example of a stage A, to establish for each consumer a consumer agent behavioral model, referenced MCCⱼ, on the basis of a plurality of behavioral primitives, the behavioral primitives being referenced PC_{j,l} to PC_{j,n} where j denotes an index identifying the consumer agent behavioral model MCCⱼ in question and where n denotes the position of the behavioral primitive PC_{j,n} in question.

In a particularly advantageous manner, it is pointed out that the consumer behavioral primitives PC_{j,n} make it possible, on the basis of stimuli variables, Sₖ, and of factual variables Fᵣ, these stimuli and factual variables consisting of incitation variables of each consumer agent behavioral model present in the virtual market MV and, in particular, generated by any participant in the virtual market MV, to establish for at least one consumer agent behavioral model, a plurality of decisional variables, referenced D_{j,k} in the context of the aforementioned virtual market MV.

The behavioral simulation method according to the invention also consists in establishing, B, for each supplier of the real market, a supplier agent behavioral model MCFₖ on the basis of a plurality of supplier behavioral primitives, referenced PC_{k,l} to PC_{k,n}, these supplier behavioral primitives making it possible, on the basis of specific data on the virtual market MV, to generate a plurality of stimuli variables, the previously mentioned stimuli variables Sₖ.

More particularly, it is pointed out that the stimuli variables Sₖ are addressed to all of the consumer agent behavioral models MCCⱼ and thus make it possible to obtain, for each consumer agent behavioral model, a set of dedicated decisional variables, which are related to the aforementioned stimuli variables Sₖ and therefore definitively to the corresponding supplier agents behavioral model in the context of the virtual market MV.

The behavioral simulation method according to the invention consists, on the basis of the set of consumer agent behavioral models MCCⱼ and of supplier agent behavioral models MCFₖ, in representing, in step C, at least literally, the dedicated decisional variables DD_{j,k} previously mentioned in the context of the virtual market MV in question.

The aforementioned representation can advantageously be produced in the form of emergent phenomena representative of one or more behavioral tendencies for at least one consumer agent model MCCⱼ and definitively for at least one respectively real consumer in the context of the virtual market.

A more detailed description of the consumer PC_{j,n} and supplier PC_{k,n} behavioral primitives respectively will now be given with reference to FIGS. 1b and 1c.

In general terms, it is pointed out that the consumer behavioral primitives consist of elements of the transfer function type, which, for a specified stimuli variable Sₖ make a decisional variable D_{j,k} correspond, each aforementioned decisional variable being representative of an opinion of the consumer agent behavioral model with reference to a given stimuli variable Sₖ generated by a supplier agent or to a factual variable Fr. In general terms, it is pointed out that a set of decisional variables D_{j,k} generated by the set of behavioral primitives PC_{j,n} constituting a consumer agent behavioral model MCCj is representative, for the aforementioned consumer agent behavioral model, of a consumption opinion with respect to one or to a set of products or services offered on the virtual market MV, and therefore on the real market, by the supplier agent model MCFₖ in question.

With regard to the supplier behavioral primitives PC_{k,m}, it is pointed out that these can be simplified with respect to the consumer behavioral primitives. Thus, the supplier behavioral primitives PC_{k,m} can essentially consist of a simplified transfer function of the context:action type, the action in this case corresponding to the issue of a stimuli variable Sₖ, as will be described later in the description.

With reference to FIG. 1b, it is pointed out that the consumer behavioral primitives PC_{j,n} comprise at least conditioning represented by at least one consumption habits parameter, imitation represented by at least one parameter for reproducing the dominant value in its neighborhood of at least one decisional variable generated by a behavioral primitive of a neighboring consumer agent behavioral model, opportunism represented by at least one parameter of reactivity to a stimuli variable Sₖ of the virtual market MV and, finally, distrust of, attraction to the innovative character of the product or of the service offered by the supplier behavioral model MCFₖ in question. The aforementioned distrust, attraction behavioral primitive can relate to the innovative character of an offer of a set of products or specific services proposed or provided in the form of stimuli variables by at least one of the supplier agent behavioral models.

Similarly, with reference to FIG. 1c, it is pointed out that the behavioral primitives PC_{k,m} comprise at least the generation of customer loyalty represented by at least one parameter related to the brand image of the supplier agent model, the frequency of publicity campaigns, the relative attraction to the similar product or service proposed by each supplier agent behavioral model MCFₖ in question.

A way of using the method for behavioral simulation of a plurality of consumers, according to the present invention, will now be described with reference to FIGS. 2a and 2b.

In FIG. 2a there has been shown the interactions between the different categories of participants, that is to say of behavioral agent models, allowing the use of the method according to the present invention. In the aforementioned FIG. 2a, it is possible to observe that the stimuli variables Sₖ, the decisional variables and the dedicated decisional variables are updated interactively according to a plurality of one-to-one interactions.

With reference to the aforementioned figure, the aforementioned interactions comprise at least the consumer agent behavioral model/consumer agent behavioral model interaction. This interaction is a two-way one-to-one interaction between two neighboring consumer agent behavioral models referenced MCCⱼ and MCCⱼ₊ₚ. The aforementioned consumer agent behavioral models are of course themselves subject to the influence of the virtual market MV. The two-way one-to-one interaction is represented by a two-directional continuous single line.

Furthermore, the aforementioned interactions also comprise a supplier agent behavioral model MCFₖ/consumer agent behavioral model, MCCⱼ and MCCⱼ₊ₚ respectively, interaction. In such a case, the interaction is one-to-one and two-way by the intermediary of the virtual market MV. For this reason, these interactions are represented by two arrows, one arrow in continuous line representing a stimuli variable Sₖ issued by the supplier agent behavioral model MCFₖ to each of the consumer agent behavioral models MCCⱼ and MCCⱼ₊ₚ respectively. On the contrary, the consumer agent behavioral model/supplier agent behavioral model interaction is represented by an arrow drawn in dotted line, the representation in dotted line indicating an indirect interaction by the intermediary of the virtual market MV and, in particular, by any dedicated decisional variable DDⱼ₊ₖ transmitted by the intermediary of the virtual market MV to any diligent and vigilant supplier agent behavioral model MCFₖ.

Finally, the aforementioned interactions can also comprise the virtual market/consumer agent behavioral model MCCⱼ interaction, and respectively the virtual market/supplier agent behavioral model MCFₖ interaction, insofar as one or other of these behavioral agents is rendered sensitive to any factual variable present in the virtual market MV, these factual variables possibly corresponding to rumors or, as appropriate, to any action not controlled by one or other of the aforementioned behavioral agents. In the previously mentioned FIG. 2a, it is indicated that the factual variables, such as rumors for example, are referenced Fᵣ, these factual variables of course being conveyed by the virtual market MV.

A more specific way of operating between the various participants, that is to say the various consumer/supplier agent behavioral models shown in FIG. 2a will now be described with reference to FIG. 2b.

The interaction model shown in FIG. 2b in fact takes account of two categories of interactions between the consumer agent behavioral model, referenced MCCⱼ, the supplier agent behavioral model MCFₖ and the interaction with the entourage, that is to say the environment of the virtual market, referenced EMV.

The interaction between consumer agent MCCⱼ and supplier agent MCFₖ behavioral models is, as mentioned previously, one-to-one and two-way. The consumer agent behavioral model MCCⱼ is subjected to the various publicity actions planned by the suppliers according to a market research strategy, that is to say a commercial action strategy. This strategy depends for example on the evolution of the turnover expressed by the number of customers and the total number of products or services consumed for each corresponding supplier agent behavioral model MCFₖ. The publicity campaigns denoted by advertisements, brand images, quality/price, publicity for innovative services and customer loyalty actions are part of the environment of the virtual market EMV. They cause a positive or negative retroaction on the consumer agent behavioral model MCCⱼ by the intermediary in particular of the corresponding stimuli variables Sₖ. Thus, these publicity campaigns modify the behavioral attitudes depending on the characteristics of the publicity campaign, in a particular the type and intensity, on the actual status of attitudes corresponding to the decisional variables delivered by the behavioral primitives PC_{j,n} for the corresponding consumer behavioral model MCCⱼ.

In return, of course, the consumption decisions, that is to say the value of the dedicated decisional variables DD_{j,k} resulting from the combination of the decisional variables D_{j,k}, cause the evolution of the market shares of any supplier agent behavioral model MCFₖ and, consequently, influence their commercial strategy or market research strategy. Such a dynamic loop of interactions by positive retroaction between consumer agent behavioral model and supplier agent behavioral model constitutes an essential modeling element of a virtual market and of implementation of a method or of a system for behavioral simulation of a plurality of consumers by multi-agent simulation according to the present invention.

Other events, again denoted by factual variables Fᵣ, can influence the decision to purchase of the consumer agent behavioral model and, of course, the behavioral attitudes of the latter.

These events are part of the environment of the virtual market EMV and can arise from the entourage of the consumer agent behavioral model MCCⱼ in question. By way of non-limitative example, it is pointed out that, by convention, the entourage is not necessarily constituted by a consumer and that it is not therefore essential to model the entourage in consumer agent behavioral model form. This is particularly the case for very high technology and high added value products or services for which a consumer agent behavioral model can be influenced by way of incitation to modernism by the publicizing of a single thought. In the context of this entourage, it is possible to define the factual variables Fᵣ which correspond to recommendations, gifts and, if appropriate, to rumors.

Rumors (including advertising), Rumor, can act positively or negatively on opinion, that is to say on the decisional variables delivered by the previously mentioned behavioral primitives of the consumer agent behavioral model and, in particular, according to the variables delivered by the imitation and/or distrust behavioral primitives.

Thus, with reference to FIGS. 2a and 2b, it can be seen that any fact or event Fr of the environment of the virtual market EMV intervenes in a unidirectional univocal way on the consumer agent behavioral model MCCⱼ.

With reference to FIG. 2b, it is indicated that the conditioning, imitation, opportunism, distrust of and attraction to innovation behavioral primitives can be parameterized depending on the profile of the corresponding consumer and in particular on the age, income and social mobility of the latter.

Finally, any dedicated decisional variable is representative of an action by the consumer agent behavioral model MCCⱼ, this action being analyzed as a purchase, or respectively a use of the product or service proposed by the behavioral model MCFₖ. Each dedicated decisional variable, that is to say the action in the context of the virtual market MV, is then varied by a necessity variable, this necessity variable itself being able to represent a professional or respectively a private necessity, able to be linked with the profile of the user.

With reference to FIG. 2b, it is pointed out that the emergent phenomena can then be revealed by filtering, with specific criteria, for the purpose of producing specific data structures, these data structures being represented in the form of tendency variables in order to allow an interactive updating of the virtual market representative of the modeling of a real market. This operation can be carried out by an influence of the tendency variables on the stimuli variables Sₖ.

With reference to the same FIG. 2b, it can be seen in particular that each behavioral primitive allowing the definition of a consumer agent behavioral model MCCⱼ is a function of at least one factual variable, the factual variables being able to include the stimuli variables Sₖ.

A more detailed description of the use of a dedicated decisional variable DD_{j,k} on the basis of a set of decisional variables D_{j,k}; D_{j,k+1}; D_{j,k+2} delivered by the imitation, conditioning, opportunism, attraction to innovation and distrust behavioral primitives will now be given with reference to FIGS. 3a to 3c.

In general terms, as mentioned previously in the description, it is recalled that each behavioral primitive in fact constitutes a non-linear transfer function and delivers a variable, a decisional variable, which depends on at least one factual variable, or respectively on a stimuli variable Sₖ.

With reference to FIG. 3a, it is pointed out that each decisional variable delivered by each behavioral primitive is reinforced positively or respectively negatively, by at least one factual variable or a stimuli of the virtual market MV. In FIG. 3a, it is pointed out that the factual variables, that is to say the actual factual variables Fᵣ and the stimuli variables Sₖ, can be constituted by the recommendation (Recommendation), novelty (Novelty), Publicity (Pub), rumor (Rumor), promotion (Promotion) or bonus (Bonus) variables.

According to a particularly advantageous embodiment of the method according to the present invention, it is pointed out that the imitation behavioral primitive is reinforced positively by a Recommendation factual variable and negatively by a Novelty factual variable. Similarly, the conditioning behavioral primitive is reinforced positively by a Publicity stimuli variable and negatively by a Rumor factual variable.

Similarly, the Opportunism behavioral primitive is reinforced positively by a Promotion stimuli variable. The Attraction to Innovation behavioural primitive is reinforced positively by a Novelty factual variable and negatively by a Recommendation factual variable.

Finally, the Distrust behavioral variable is reinforced positively by a Rumor factual variable and negatively by a Publicity stimuli variable.

Thus, with reference to FIG. 3a, it is pointed out that:

the attraction to innovation behavioral attitude delivered by the Attraction Innovation behavioral primitive is used to represent the attraction that a consumer agent behavioral model has to novelties. This attitude is reinforced positively by the appearance of new products on the market and, on the contrary, it is reinforced negatively by the recommendations of the entourage of the consumer agent behavioral model in question.

The Imitation behavioral attitude is used to represent the influence that the opinion of the entourage of a consumer agent behavioral model has on the latter's choice. This attitude is reinforced positively by the recommendations of the entourage and negatively by the appearance of new products on the market.

The Opportunism behavioral attitude is used to represent the faculty of a consumer agent behavioral model to seize opportunities. This attitude is reinforced positively by promotional offers, including loyalty bonus offers.

The Conditioning behavioral attitude is used to represent the conditioning of a consumer agent behavioral model to the consumption of branded products. This attitude is reinforced positively by advertisements and negatively by rumors.

The Distrust behavioral attitude is used to represent the distrust of a consumer agent behavioral model in consuming products. This attitude is reinforced positively by rumors and negatively by advertisements.

The function of the behavioral primitives PC_{j,n} constituting the consumer agent behavioral models is to determine the opinion that the latter may have with respect to each supplier in the context of the competitive market. The aforementioned opinion therefore determines the supplier's choice when the consumer agent behavioral model carries out an act of consumption. The acts of consumption can then be activated cyclically by a necessity event, as described previously with reference to FIG. 2b. This cycle depends on the socio-economic profile of the consumer agent behavioral model in question. It is pointed out that the necessity variables make it possible to regulate the knowledge of the virtual market and, consequently, of the real market. A necessity variable can consist, for example, of a percentage value of the population in question which is considered to carry out an act of consumption according to an opinion. The necessity variables are economic variables.

Thus, with reference to FIG. 3a, it is pointed out that each dedicated decisional variable DD_{j,k}, which is representative for a consumer agent behavioral model of a consumption opinion, is established on a criterion of comparison of all the aforementioned decisional variables with at least one consumption opinion threshold value.

The process of comparison of all the decisional variables with at least one consumption opinion threshold value will now be described with reference to FIG. 3b.

FIG. 3b represents the non-linear transfer function of each behavioral primitive, Imitation, Conditioning, Opportunism, Attraction to Innovation and Distrust, with respect to factual variables Fᵣ and external stimuli variables Sₖ which are applied to them.

In the context of a preferred implementation of the method and of the system for behavioral simulation of a plurality of consumers by multi-agent simulation according to the present invention, it is pointed out that the factual variables, including the stimuli variables, are advantageously represented by numerical values contained within a range of values representative of the intensity of each factual variable and stimuli variable respectively. In a preferred embodiment, it is pointed out that the aforementioned variables are standardized and their value is a real number between 0 and 1.

Thus, a behavioral primitive is defined on the basis of external stimuli variables Sₖ, these variables being characterized by an intensity, referenced Intensite-St-Ex, and by a type of stimuli, referenced Type-St-Ex, and by an attribute representative of the supplier originating this stimuli variable. In a preferred embodiment, it is pointed out that the attribute representative of the supplier can be constituted by a color, for example, or by a code representative, if necessary, of a color. The attribute is referenced Couleur_St_Ex.

The external stimuli themselves are defined with respect to sets of positive and negative external stimuli types which activate the behavioral primitive in question. These stimuli types are referenced {Type_St_Ex}_{PC+} and {Type_St_Ex)_{pc-}. Finally, each behavioral primitive delivers an elementary behavioral primitive value, referenced generically as V_{pc}.

With reference to FIG. 3b, it is indicated that the consumption opinion threshold value comprises at least one threshold value triggering a modification of a consumption opinion, referenced S_Dec, this consumption opinion threshold value being representative of the level of the value of the behavioral primitive above which the factual variable or the stimuli variable Sₖ respectively causes an impact on the opinion of the consumer agent behavioral model. The opinion threshold value also comprises an upper inhibiting threshold value, referenced S_Inhₛᵤₚ, this value being representative of a limit value above which the intensity of the factual variables, and stimuli variables respectively, with negative reinforcement do not cause any reinforcement of the behavioral primitive or of the elementary value V_{pc} finally delivered by the latter, irrespective of the intensity characteristics of these factual variables.

The opinion threshold value finally comprises a lower inhibiting threshold value, referenced S_Inh_{inf}, below which the factual variables, and stimuli variables respectively, with positive reinforcement do not cause any reinforcement of the behavioral primitive or of the elementary value of the latter, irrespective of the intensity characteristics of these factual variables.

In FIG. 3b, the non-linear transfer function of each behavioral primitive has been represented by two diagrams, a first diagram I corresponding to the stimuli variables or factual variables St_Ex belonging to the type of factual variables with positive reinforcement, and respectively a second diagram II corresponding to the type of factual variables with negative reinforcement, these types being referenced {Type_St_Ex}_{pc+} and {Type_St_Ex}_{pc-}.

Thus, on the appearance of a stimuli variable Sₖ, a test referenced 1000⁺and 1000⁻respectively consists in determining if this variable is perceived by the corresponding behavioral primitive. This perception test can consist in determining that the aforementioned stimuli variable is active for the behavioral primitive in question. The activity test can consist of a test of belonging of an identifier of the stimuli variable to a list of stimuli variables considered as active for the behavioral primitive in question. Furthermore, it is pointed out that in FIG. 3b, the perception tests 1000⁺ and 1000⁻ are carried out for example on the basis of a perception mask as a function of the intensity of the external stimuli variable. This makes it possible to take account, for the factual variables in particular, and if necessary for the stimuli variables, of the intensity of the latter as a function of the physical distancing of the consumer agent behavioral model MCCⱼ with respect to the origin of a factual variable Fᵣ, such as a rumor, as will be described later in the description.

When there is a negative response to the test 1000⁺and respectively to the test 1000⁻, a return to a position of waiting for external stimuli is carried out.

On the contrary, when there is a positive response to the test 1000⁺ and to the test 1000⁻ respectively, the stimuli variable present on one of the inputs of the behavioral primitive being perceived by the latter, a test for discriminating the type of stimuli, that is to say the type of reinforcement carried out by the latter, is carried on in step 1001⁺ and in step 1001⁻ respectively. This test consists of a test of belonging to a declaration of positive or negative reinforcement of the corresponding stimuli variable, of belonging to a list of reinforcement types such as mentioned previously.

When there is a negative response to the test 1001⁺ and respectively to the test 1001⁻, the process is returned to the position of waiting for an external stimuli. When there is a positive response to the test 1001⁺ and to the test 1001⁻ respectively, a test 1002⁺and respectively 1002⁻is carried out, which makes it possible to compare the elementary value V_{pc} with the lower, and respectively with the upper inhibiting threshold value, in order to carry out a segmentation of the population according to the inhibition threshold values.

When there is a negative response to the test 1002⁺ and respectively to the test 1002⁻, a return to the position of waiting for external stimuli is carried out. When there is a positive response to the test 1002⁺ and respectively to test 1002⁻, the elementary value V_{PC} is incremented by one increment value or respectively decremented by that same increment value. The increment value depends on the elementary value V_{PC} and on the intensity of the external stimuli variable. This function is written as Inc(V_{PC},Intensité_St_Ex) . It is pointed out that by instantiation of the elementary value V_{PC} at the augmented, and respectively diminished, previous value by the increment value, such an operation makes it possible to reinforce, and respectively to diminish, the elementary value V_{PC}.

Following steps 1003⁺ and 1003⁻, a test 1004⁺ and 1004⁻ respectively is carried out, a test of comparison of the value updated by incrementing, or decrementing respectively, of the elementary value V_{PC} with the triggering threshold value S_Dec previously mentioned in the description. When there is a negative response to the test 1004⁺, and test 1004⁻ respectively, a return to the state of waiting for an external stimuli variable is carried out. When there is a positive response to tests 1004⁺ and 1004⁻, a calculation of the impact of opinion is carried out on the basis of the updated value of the elementary value V_{PC}, of the external stimuli type, reinforcement or respectively diminishing, of the attribute, that is to say of the color representative of the supplier, and of course of the intensity of the external stimuli in question.

With reference to FIG. 2b or to FIG. 3a, it is pointed out that the calculation of opinion impact makes it possible to determine the decisional variable D_{j,k}; D_{j,k+1} and D_{j,k+2} relating to the supplier k, k+1 and k+2, that is to say of attributes or of corresponding colors k, k+1 and k+2.

In FIG. 3a it is shown, by way of non-limitative example, that the color blue is allocated to the attribute k in order to obtain a decisional variable or opinion Opinion_{B}, the color red is allocated to the attribute k+1 in order to obtain the decisional variable corresponding to the opinion for the red supplier denoted by Opinion_{R} and, finally, the color green is allocated to the attribute k+2 in order to obtain the decisional variable corresponding to the opinion of the green supplier denoted by Opinion_{V}.

The calculation of the dedicated variable DD_{j,k} determining the act of consumption generated by the effector on the basis of the necessity variable is then carried out depending on the opinions and in certain cases on the necessity variable.

The way of using each behavioral primitive shown in FIG. 3a whose non-linear transfer function is shown in FIG. 3b can then be summarized in the macroscopic sense, that is to say with respect to factual variables or external stimuli variables with reference to FIG. 3c as follows:

the aforementioned behavioral primitive is in a so-called inactive state when the current elementary value V_{PC} is greater than or equal to the lower inhibiting threshold value S_Inh_{inf} or when this current elementary value V_{PC} is less than or equal to the upper inhibiting threshold value S_Inh_sup.

on the contrary, the behavioral primitive is receptive but without effect on opinion when the current elementary value V_{PC} is between the lower inhibiting threshold values and satisfies the expression:

S_Inh_{inf}<V_{PC}<S_Inh_{sup.}

on the contrary, the behavioral primitive is receptive with effect on the purchase opinion when the current elementary value V_{PC} is greater than or equal to the triggering threshold value S_Dec.

When the elementary value V_{PC} again becomes lower than the triggering threshold value of an act of consumption, previously denoted S_Dec, the behavioral primitive returns to the previous state, the receptive state, without effect on opinion. Finally, when the current elementary value V_{PC} again becomes greater than the lower inhibiting threshold value S_Inh_{inf} or when this same current elementary value becomes lower than the upper inhibiting threshold value S_Inhₛᵤₚ, the behavioral primitive again returns to the inactive state.

A specific way of managing consumer agent behavioral model/consumer agent behavioral model interactions will now be given with reference to FIG. 4.

In general terms, with reference to the aforementioned figure, it is pointed out that each consumer agent behavioral model propagates rumors and recommendations, that it to say the factual variables Fᵣ for which a voluntary or involuntary action is carried out, in the form of messages around it.

In these conditions, the consumer agent behavioral model/consumer agent behavioral model interaction can advantageously consist in defining for each consumer agent behavioral model, with respect to neighboring consumer agent behavioral models, a field of influence defined as a spatial extent of communication with neighboring consumer agent behavioral models.

Furthermore, and according to a noteworthy aspect of the method according to the present invention, a law of propagation in this field of influence of factual variables Fᵣ and/or of stimuli variables Sₖ generated by any current consumer agent behavioral model with respect to a neighboring consumer agent behavioral model is then established. This law of propagation can consist in generating a diminishing of the intensity of each factual or stimuli variable as a function of the distance separating the current consumer agent behavioral model from the neighboring consumer agent behavioral models.

Thus, the field of influence and the law of propagation make it possible to limit the extent of the communication of rumors or recommendations with respect to the neighborhood. The messages are propagated according to a gradient since the intensity of the message, that is to say the intensity of the corresponding stimuli or factual variable, diminishes as a function of the distance from the target agent. In fact, it is considered in any hypothesis that the degree of communication between individuals, and therefore between the corresponding consumer agent behavioral models, is a function of their spatial proximity. Thus, with reference to FIG. 4, the intensity αi of a message, that is to say of a factual variable transmitted by the behavioral model of a consumer agent Cᵢ and whose field of influence is equal to 3, diminishes as a function of the distance from the receiver consumer agent behavioral model as shown in FIG. 2. In these conditions, the intensity of the factual variable diminishes and depends on the opinion regarding the suppliers present in the virtual market MV. Thus, the consumer agent behavioral model reacts to the various events mentioned previously by weighing the opinion that is has with respect to each supplier according to its behavioral attitudes. By way of example, it is pointed out that rumors have a greater negative impact on the opinion of consumer behavioral agents whose behavior is characterized by a high degree of distrust. In the case of a consumer agent behavioral model having a dominant opportunist behavior, the opinion with regard to a supplier who proposes commercial offers is reinforced positively.

The method according to the present invention as described previously, is such that the consumer agent behavioral models do not have a global perception of their environment consisting of other consumer or supplier agent behavioral models. They act in this environment according to their behavioral attitudes which evolve over time.

A more detailed description of a system for behavioral simulation of a plurality of consumers, by multi-agent simulation, will now be given with reference to FIGS. 5a to 5d and the following figures.

In FIG. 5a, there has been shown the architecture of a system for behavioral simulation of a plurality of consumers by multi-agent simulation according to the present invention.

In general terms, it is pointed out that this system comprises a computer, this computer comprising in a conventional manner a Central Processing Unit CPU, memory units, such as a Read Only Memory ROM and a working Random Access Memory referenced RAM, as well as all the peripheral elements necessary for the implementation of an interactive dialogue between the computer, referenced O, and all of the programs loaded from any mass memory such as a Hard Disk HDD or, if necessary, a read only memory ROM, into the random access memory for the implementation of the method according to the present invention.

As shown in a preferred and non-limitative way in FIG. 5a, the computer O is a normally commercially available portable computer allowing any user to start the program for implementing the method according to the present invention at any time and at any place on a given site.

As shown in a non-limitative way in FIG. 5a, the aforementioned computer comprises, in particular, a Graphic User Interface, referenced GUI, making it possible, due to the use of any adapted operating system, to call up any function carried out by the corresponding program or to implement the method according to the present invention.

As shown in the aforementioned FIG. 5a, the system according to the present invention comprises, stored on the hard disk HDD for example or in any adapted mass memory and for the purpose of loading into the working random access memory RAM a software module, referenced MOD₁, in FIG. 5a, making it possible to establish, for each consumer, a consumer agent behavioral model on the basis of a plurality of consumer behavioral primitives in the context of the virtual market MV.

In particular it is understood that the software module MOD₁, comprises a software sub-module, referenced SMOD₁, allowing the definition and the calling up of the conditioning, imitation, opportunism, distrust and attraction to innovation behavioral primitives previously described in the description. The aforementioned behavioral primitives of course make it possible, on the basis of stimuli variables Sₖ and if appropriate factual variables Fᵣ, to establish, for each consumer, by the intermediary of each consumer agent behavioral model, all of the decisional variables D_{j,k} in the context of the virtual market and of course all of the dedicated decisional variables DD_{j,k} previously mentioned in the description.

Besides the sub-module SMOD₁, the software module MOD₁ comprises a second sub-module SMOD₂ allowing the generation of the necessity variable dependent on parameters related to the professional and/or private life of the consumer agent behavioral model and a third software sub-module, referenced SMOD₃, allowing the taking into account of the profile of the modeled consumer, that is to say the profile attributed to the consumer agent behavioral model according to the age, income and social and/or professional mobility of the corresponding consumer.

Finally, a software sub-module, referenced SMOD₄, is provided, which makes it possible to calculate, on the basis of the decisional variables D_{j,k} and of the necessity variable, to calculate the corresponding dedicated decisional variable DD_{j,k}, as described previously with reference to FIG. 2b.

With regard to the use of the system according to the present invention such as shown in FIG. 5a, it is pointed out that the software module MOD₁, constituted by the software sub-modules SMOD₁ to SMOD₄ corresponds, functionally speaking, to the operating process shown for the behavioral agent MCCⱼ in FIG. 2b.

Furthermore, as shown in FIG. 5a, the system according to the present invention comprises a software module MOD₂ making it possible to establish for each supplier a supplier agent behavioral model on the basis of a set of supplier behavioral primitives in the context of the virtual market MV.

As mentioned previously in the description, the supplier behavioral primitives make it possible of course, on the basis of specific data on the virtual market, to generate stimuli variables Sₖ addressed to all of the consumer agent behavioral models, which by retroaction, as described previously, deliver dedicated decisional variables DD_{j,k}, on the basis of the aforementioned stimuli variables.

In FIG. 5a, there has furthermore been shown an additional software module, referenced MOD₃, this software module corresponding to a segmentation module, that is to say a module for filtering the stimuli variables Sₖ delivered by each supplier. It can thus be seen that the user of the system according to the present invention, that is to say an agent authorized by a supplier for example whose supplier agent behavioral model has or has not been entered in the simulation system according to the present invention, can then target these stimuli variables by segmentation, and therefore by filtering, according to his own criteria. These criteria are related, for a given product or service, to specific parameters of each consumer, that is to say of each consumer behavioral agent entered into the system according to the present invention and represented by a software module MOD₁.

With regard to the virtual market MV and, more specifically, the environment of this virtual market EMV, this environment can be represented advantageously by specific data structures, these data structures being referenced:

MO₄ for data structures relating to brand image publicity such as price and quality and to publicity for innovative services or for loyalty generation actions;

MO₅ for data structures relating to recommendations, gifts or rumors corresponding to the issue of factual variables Fᵣ for example, the module MO₄ making it possible to deliver stimuli variables Sₖ;

MO₆ for data structures corresponding to the entourage relating to the consumer agent behavioral model defined and called up by the aforementioned module MOD₁, this data structure being able to be representative of parameters relating to the family or friends of the consumer modeled by the aforementioned consumer agent behavioral model.

All of the aforementioned software modules and software sub-modules and/or data structures shown in FIG. 5a of course allow, by calling up the aforementioned modules, sub-modules and data structures, the carrying out of the functional process shown in FIG. 2b.

Finally, it is pointed out that the segmentation software module MOD₃, in addition to the aforementioned filtering operations, allows, by the intermediary of the operating system of the computer O, the calling up of a display and selection module on the graphical display unit GUI of a representation, at least in literal form, of dedicated decisional variables DD_{j,k} in the context of the virtual market MV. These decisional variables are represented in the form of emergent phenomena representative of one of more behavioral tendencies for at least one of the consumers in the context of the aforementioned virtual market.

With regard to the representation of the aforementioned behavioral tendencies, it is pointed out that a simple exemplary implementation can consist in producing tables of behavioral tendency parameter values, these tables of values being able to consist of values sorted by increasing or decreasing value and thus correspond to tables directly readable and usable by the user of the system according to the invention. Such a process of representation and display will not be described in detail since it corresponds to the use of sorting and display of parameters programs known to those skilled in the art.

Various preferred particular embodiments and implementations of the system according to the present invention will now be described with reference to FIGS. 5b, 5c and 5d.

The description of these preferred embodiments corresponds to an implementation in the SWARM environment, a simulation environment freely available commercially and produced in the objective-C language. This simulation environment is available at the html address: http://www.swarm.org.

This software module makes it possible to simulate a set of consumer and/or supplier agent behavioral models and to produce a display in elaborated graphical form much more powerful than a simple literal representation of the simulation process and of the emergent phenomena in the form of behavioral tendencies, as will be described hereafter in the description.

In general terms, it is pointed out that the system according to the present invention makes it possible to provide a stage of initialization of all simulations, this initialization essentially relating to the profile of the consumers, the characteristics of the simulated market as well as to the market research or conquest strategy adopted by each supplier.

For this purpose, the module for display by the intermediary of the graphical user display unit GUI comprises at least the display of a screen page for the entry of specific parameters representative of the socio-professional profile associated with the behavioral model of each consumer agent. This screen page comprises, for example, a plurality of entry fields relating to parameters defining value ranges for all of the consumers of the population, for example the maximum age, and average values, such as the average value of the imitation primitive.

In a preferred embodiment, and in order to optimize the initialization of each simulation, it is pointed out that the initialization can be initialized on the basis of a first screen page as shown in FIG. 5b, a screen page referred to as AgentModel.

By way of non-limitative example, the various entry fields for the aforementioned first screen page are referenced by a field reference Ref C varying from 1 to 16, the entry parameters or variables comprising a specific designation as shown in FIG. 5b.

The function of each variable indicated by reference to the field reference is given in Table I below.

TABLE I

| Ref C | FIG. 5c: Some parameters of the simulation | |
|---|---|---|
| (1) | Year | Indicator of the duration of the |
| | | simulation |
| (2) | NumAgents | Number of consumer agents in the |
| | | simulated population |
| (3) | Density | Degree of proximity between the indi- |
| | | viduals of the population |
| (4) | PercentSubscriber | Initial percentage of individuals |
| | | equipped with a mobile |
| (5) | PercentXSubscriber | Initial percentage of individuals |
| | | equipped with an X mobile |
| (6) | MinRentalDuration | Minimum duration of subscription |
| (7) | MaxRentalDuration | Maximum duration of subscription |
| (8) | MaxAge | Age limit of individuals when initial- |
| | | izing the simulation |
| (9) | MaxVision | Maximum field of perception of con- |
| | | sumer agents |
| (10) | MaxSalary | Average income or salary |
| (11) | MaxFriends | Maximum number of friends in the |
| | | entourage of a consumer agent |
| (12) | ImitationCoefficient | Significance of the imitation behavioral |
| | | attitude in the population when initial- |
| | | izing the simulation |
| (13) | InnovationCoefficient | Significance of the attraction to inno- |
| | | vation behavioral attitude in the popul- |
| | | ation when initializing the simulation |
| (14) | ConditioningCoefficient | Significance of the conditioning |
| | | behavioral attitude in the population |
| | | when initializing the simulation |
| (15) | DistrustCoefficient | Significance of the distrust behavioral |
| | | attitude in the population when initial- |
| | | izing the simulation |
| (16) | OpportunismCoefficient | Significance of the opportunism behavi- |
| | | oral attitude in the population when |
| | | initializing the simulation |

It is understood in particular that the aforementioned screen page shown in FIG. 5b makes it possible to specify the aforementioned parameters.

Furthermore, as shown in FIG. 5c, and for the purpose of adjusting the modeling of each consumer, that is to say in fact of optimizing the implementation of the corresponding software module MOD₁ for each consumer agent behavioral model, a screen page, referred to as Agent, comprises the fields for observation and modification of the parameters or variables referenced by the Field reference from 1 to 25, each field corresponding to a variable or parameter designated in FIG. 5c and whose function is entered in Table II below.

TABLE II

| Ref C | FIG. 5c: Consumer agent | |
|---|---|---|
| (1) | Necessity | Degree of necessity of consumption depending on the socio- |
| | | economic profile of the consumer agent |
| (2) | x | Coordinates of the consumer agent on the social proximity map |
| (3) | y | Coordinates of the consumer agent on the social proximity map |
| (4) | xbeh | Coordinates of the consumer agent on the behavioral attitudes |
| | | map |
| (5) | ybeh | Coordinates of the consumer agent on the behavioral attitudes |
| | | map |
| (6) | FirstTimeSub | Indicator of a first purchase |
| (7) | SocialMobility | Degree of social mobility |
| (8) | ProfessionalMobility | Degree of professional mobility |
| (9) | World | Market space |
| (10) | BehaviorMap | Representation of tendencies |
| (11) | WorldXYSize | Size of the social proximity map over which the agent moves |
| (12) | BehaviourMapXYSize | Size of the behavioral attitudes map on which the behavioral |
| | | profile of the consumer agent is represented |
| (13) | Inov | Value of the behavioral primitive: attraction to innovation |
| (14) | Imit | Value of the behavioral primitive: imitation |
| (15) | Cond | Value of the behavioral primitive: conditioning |
| (16) | Mefi | Value of the behavioral primitive: distrust |
| (17) | Oppo | Value of the behavioral primitive: opportunism |
| (18) | BehavioralAttitudes | List of components of each behavioral primitive |
| (19) | AgentColor | Color of the consumer agent indicating the supplier of the |
| | | purchased product |
| (20) | ModelSwarm | Reference to the simulation model according to which the |
| | | consumer agent is created (FIG. 5b) |
| (21 | Age | Age of the consumer agent |
| (22) | Salary | Salary of the consumer agent |
| (23) | Opinions | List of opinions with respect to suppliers in the simulated market |
| (24) | RentalDuration | Duration of the current subscription to an operator |
| (25) | Vision | Measurement of the field of perception (influence) of the |
| | | consumer agent. |

Finally, in order to initialize each supplier agent behavioral model, a screen page is provided, as shown in FIG. 5d, this screen page being for example dedicated to the supplier B previously mentioned in the description.

By way of non-limitative example, it is pointed out that each supplier agent behavioral model can thus be represented by the behavioral primitives corresponding to a simplified transfer function of the context: action type previously mentioned in the description.

Thus, with reference to FIG. 5d, it is pointed out that four fields for the entry of context parameters or variables, whose field references vary from 1 to 4, and two fields for the entry of action parameters or variables related to each context field are provided and referenced .1, .2 in FIG. 5d. By way of non-limitative example, it is understood that each action field corresponds to a duration for the sub-field .1 and respectively to an intensity for the sub-field .2. It is understood in particular that each action sub-field must be read in conjunction with the corresponding context field.

The function of the variables or parameters corresponding to the context field and sub-field values, shown in FIG. 5d, is given below in Table III.

TABLE III

| Ref C | FIG. 5d: Types of publicity | |
|---|---|---|
| (1) | LoyaltyPublicity | Publicity action aimed at creating loyalty |
| (2) | BrandPublicity | Publicity action relating to brand image |
| (3) | PromotionalPublicity | Publicity action of promotion |
| (4) | NewServicePublicity | Publicity action for innovative services/ |
| | | products |
| (.1) | Duration | Duration of a publicity action |
| (.2) | Pub Intensity | Intensity of a publicity action (frequency |
| | | of diffusion) |

A preferred embodiment of the process of representation and display of the dedicated decisional variables in the form of behavioral tendencies will now be described with reference to FIGS. 6a to 6c and 7a to 7d.

In general terms, with reference to FIG. 6a, it is pointed out that the entry of Grid2d variables in the fields (9) and (10) of FIG. 5c corresponding to the agent screen page has the effect of allowing the representation of each agent by a point in a rectangular space in the form of a grid, for each consumer agent, for a given product or service proposed by a supplier behavioral agent, being allocated the attribute, that is to say finally the color allocated to that supplier behavioral agent, when the consumer agent behavioral model has chosen the product or service proposed by the aforementioned supplier agent behavioral model.

Thus in FIG. 6a, a grid or map with Cartesian coordinates is available where each consumer agent is provided, for example, with a starting color corresponding to the attribute identifying the supplier agent. In the aforementioned figures, the colors are represented by shades of gray.

With reference to FIG. 6b, it is pointed out that the representation and display module furthermore comprises the display of a reference screen page comprising, in the active display zone of this screen page, an analog representation of the consumer agent behavioral primitives such as imitation, innovation, conditioning, distrust and opportunism.

With reference to FIG. 6b, it is pointed out that each display zone of one of the aforementioned analog representations corresponds to a zone of distribution of the decisional variables of imitation, innovation, conditioning, distrust and opportunism, the dominant decisional variable, that is to say the one whose standardized value is greatest, corresponding to the display zone of the analog representation associated with the corresponding distribution zone.

Following the use of a simulation cycle, that is to say the starting of a set of specific stimuli variables and, if appropriate, of factual variables for a plurality of supplier agent behavioral models with respect to a set of consumer agent behavioral models, the points representative of each consumer agent behavioral model and of course their attribute, that is to say their color corresponding to their decision according to the supplier finally chosen, are categorized and distributed according to the value of the aforementioned dominant decisional variable which is allocated to them and displayed in the display zone according to the relative value of the successive decisional variables in order to generate a screen page such as shown in FIG. 6c, wherein each point is then regrouped in the neighborhood of each analog representation corresponding to a distribution zone of the aforementioned decisional variables. Thus, in FIG. 6c, there is again globally seen all of the points representative of each consumer agent behavioral model and of their attribute resulting from their decision, regrouped in five zones corresponding to the display zones of the analog representations previously described with reference to FIG. 6b.

Each group of points representative of a consumer agent behavioral model corresponding to a distribution zone is therefore representative of a dominant decisional variable associated with a behavioral primitive for all of the consumer agent models.

It is thus possible, by enumeration by means of programs for enumerating in zones, to establish precise statistics and finally to reveal the emergent phenomena previously mentioned in the description.

Tests carried out in the context of a virtual market relating to products and services concerning mobile telephony have shown the emergence of a segmentation in the social proximity map of the population of consumers into zones of different colors after a period of simulation whose length essentially depends on two parameters: the population density and the field of perception, that is to say the field of influence of the aforementioned consumers.

The simulation model used by the method and the system according to the present invention has, in a particularly satisfactory manner, made it possible to reproduce the curves that are conventional in economics, curves relating to the life cycle of a product in two particular specific cases. The first case relates to a population of 5000 consumer agent behavioral models whose coefficient of attraction to innovation is higher than the imitation coefficient P₁, whilst the second case relates to a population whose imitation coefficient is higher than the coefficient of attraction to innovation P₂.

The simulation consists in observing the results of the launching of a new service by three supplier agents A, B, C in these two populations of consumers.

The simulation used then reveals two different life cycles of the new service.

In the first case, the new service was quickly adopted by all of the innovative consumers, but without, however, a stabilization of sales occurring.

On the contrary, in the second case, the number of purchasing consumers stabilizes after a period of simulation in order to give rise to a conventional curve for the life cycle of a product in a market in which the proportion of innovative individuals is low in comparison with the proportion of imitating individuals. This curve is characterized by an increase in the number of customers up to an extreme value, followed by a slight reduction and a stabilization of the consumption at a lower level than the peak achieved.

The aforementioned simulation results are shown in FIGS. 7a and 7b.

Another significant result relates to the observation of a modification of the behavioral attitudes of the consumers, and of course of the consumer agent behavioral models, following rumors started in the virtual market. The simulation process, in this case, consists in activating a factual variable Fr, or rumor, in the population of consumer agent behavioral models. The propagation of the rumor increases the degree of distrust among the individuals of the population and, consequently, the number of customers for the different operators diminishes. However, this reduction does not last, for two main reasons. A first reason consists in the fact that the operators react to this reduction by intensifying their publicity actions, whereas the second reason is that the necessity of an asset, in particular the necessity of communication for users of mobile telephones, is reinforced throughout the simulation each time that the consumer proceeds with the act of purchasing the product, that is to say when renewing the provision of service relating to the subscription. The reinforcement of the necessity variable thus corresponds with the consumer's familiarization with the product and to the services provided by that product.

The behavioral attitude which dominates within the population of consumers during the recovery phase of the clientele is opportunism, contrary to the period that precedes the activation of the rumor where imitation and conditioning are the two main behavioral attitudes that characterize the population of consumers.

In FIGS. 7c and 7d, there has been represented the behavioral distribution of the consumers before the activation of a rumor, this distribution being substantially symmetrical with respect to the distribution zone relating to conditioning, in FIG. 7c,whilst the distribution of the population after activation of a rumor represented in FIG. 7d shows the increase in the behavioral attitude of opportunism.

1. Method for behavioral simulation of a plurality of consumers, by multi-agent simulation, in the context of a virtual market, this method comprising the steps consisting in:
establishing, for each consumer or group of consumers, a consumer agent behavioral model, on the basis of a plurality of consumer behavioral primitives in the context of this virtual market, said consumer behavioral primitives making it possible, on the basis of stimuli variables and depending on the internal value of said consumer behavioral primitives, to establish, for each consumer or group of consumers, a plurality of decisional variables in the context of said virtual market;
establishing for each supplier, a supplier agent behavioral model on the basis of a plurality of supplier behavioral primitives in the context of this virtual market, said supplier behavioral primitives making it possible, on the basis of specific data on said virtual market, to generate a plurality of stimuli variables addressed to all of the consumer agent behavioral models, which makes it possible to obtain a set of dedicated decisional variables in the context of said virtual market;
representing, at least literally, said dedicated decisional variables in the context of said virtual market, in the form of emergent phenomena, representative of one or more behavioral tendencies for a plurality of consumer agents in the context of said virtual market.

2. Simulation method according to claim 1, characterized in that said virtual market is constituted by a modeling of a real market.

3. Simulation method according to one of claims 1 or 2, characterized in that said consumer behavioral primitives comprise at least conditioning represented by at least one consumption habits parameter, imitation represented by at least one parameter for reproducing the dominant value of decisional variables, opportunism represented by at least one parameter of reactivity to a stimuli variable of the virtual market, distrust of and respectively attraction to the innovative character of an offer of a set of products or specific services proposed or provided in the form of stimuli variable by at least one supplier agent behavioral model.

4. Simulation method according to one of claims 1 to 3, characterized in that said supplier agent behavioral primitives comprise at least the generation of customer loyalty represented by at least one parameter related to the brand image, the frequency of publicity campaigns, the relative attraction to similar products or services proposed by each supplier agent behavioral model.

5. Simulation method according to one of claims 1 to 4, characterized in that said stimuli variables, said decisional variables and said dedicated decisional variables are updated interactively according to a plurality of one-to-one interactions comprising at least:
the consumer agent behavioral model/consumer agent behavioral model interaction;
the supplier agent behavioral model/consumer agent behavioral model interaction;
the virtual market/supplier agent behavioral model interaction;
the virtual market/consumer agent behavioral model interaction.

6. Simulation method according to one of claims 1 to 5, characterized in that said emergent phenomena are constituted in the form of specific data structures, said specific data structures being represented in the form of tendency variables, allowing an interactive updating of said modeling of a real market, constitutive of said virtual market.

7. Simulation method according to one of claims 3 to 6, characterized in that each behavioral primitive is a function of at least one factual variable, the factual variables including said stimuli variables, each decisional variable in the context of each behavioral primitive being reinforced positively or respectively negatively by at least one factual variable of said virtual market.

8. Simulation method according to claim 3, characterized in that:
the imitation behavioral primitive is reinforced positively by a Recommendation factual variable and negatively by a Novelty factual variable;
the conditioning behavioral primitive is reinforced positively by a Publicity stimuli variable and negatively by a Rumor factual variable;
the opportunism behavioral primitive is reinforced positively by a Promotion stimuli variable;
the attraction to innovation behavioral primitive is reinforced positively by a Novelty factual variable and negatively by a Recommendation factual variable;
the distrust behavioral primitive is reinforced positively by a Rumor factual variable and negatively by a Publicity stimuli variable.

9. Simulation method according to one of claims 7 or 8, characterized in that each decisional variable relating to a consumer behavioral model is evaluated for each supplier agent behavioral model, each decisional variable being representative of an opinion of said consumer agent behavioral model with reference to one or more stimuli variables, each dedicated decisional variable, representative for a consumer agent behavioral model of a consumption opinion being established on a criterion of comparison of all of said decisional variables with at least one threshold value.

10. Simulation method according to one of claims 7 to 9, characterized in that said factual variables, including said stimuli variables, are represented by numerical values, contained within a range of values representative of the intensity of each factual variable and respectively of each stimuli variable.

11. Simulation method according to one of claims 9 or 10, characterized in that said at least one consumption opinion threshold value comprises:
a threshold value triggering a modification of opinion representative of the level of the value of the behavioral primitive above which the factual variable or the stimuli variable respectively causes an impact on the opinion of said consumer agent behavioral model;
an upper inhibiting threshold value representative of a limit value above which the intensity of the factual variables, and stimuli variables respectively, with negative reinforcement do not cause any reinforcement of the behavioral primitive, irrespective of the intensity characteristics of the latter;
a lower inhibiting threshold value below which the factual variables, and stimuli variables respectively, with positive reinforcement do not cause any reinforcement of the behavioral primitive, irrespective of the intensity characteristics of the latter.

12. Simulation method according to one of claims 5 to 11, characterized in that the consumer agent behavioral model/consumer agent behavioral model interaction consists in defining, for each consumer agent behavioral model with respect to neighboring consumer agent behavioral models:
a field of influence defined as a spatial extent of communication with neighboring consumer agent behavioral models;
a law of propagation, in this field of influence, of factual variables and/or of stimuli variables generated by any current consumer agent behavioral model with respect to a neighboring consumer agent behavioral model, this law of propagation corresponding to a diminishing of the intensity of each factual or stimuli variable respectively as a function of the distance separating the current consumer agent behavioral model from the neighboring consumer agent behavioral models.

13. System for behavioral simulation of a plurality of consumers, by multi-agent simulation in the context of a virtual market, this system at least comprising, in a computer comprising a central processing unit and a working random access memory and a graphical display unit:
a software module making it possible to establish for each consumer a consumer agent behavioral model on the basis of a plurality of consumer behavioral primitives, in the context of this virtual market, said consumer behavioral primitives making it possible, on the basis of stimuli variables and of these consumer behavioral primitives, to establish for each consumer a plurality of decisional variables in the context of this virtual market;
a software module making it possible to establish for each supplier a supplier agent behavioral model on the basis of a plurality of supplier behavioral primitives in the context of this virtual market, said supplier behavioral primitives making it possible, on the basis of specific data on this virtual market, to generate a plurality of stimuli variables, addressed to all of the consumer agent behavioral models, all of the consumer agent behavioral models delivering, on the basis of these stimuli variables, a set of dedicated decisional variables in the context of this virtual market;
means of display and selection on said graphical display unit of a representation, at least in literal form, of said dedicated decisional variables in the context of this virtual market, in the form of emergent phenomena, representative of one or more behavioral tendencies for at least one consumer in the context of this virtual market.

14. System according to claim 13, characterized in that said software model making it possible to establish for each consumer a consumer agent behavioral model comprises:
a software sub-module for processing behavioral attitudes, this sub-module comprising a sub-program for processing conditioning, imitation, opportunism, distrust or attraction to innovation, each sub-module receiving all of the stimuli variables delivered by said software module making it possible to establish for each supplier a supplier agent behavioral model, said software sub-module for processing behavioral attitudes making it possible to deliver for each consumer agent behavioral model a plurality of decisional variables in the context of this virtual market;
a software sub-module for acquiring and processing necessity variables, each one associated with each consumer agent behavioral model;
a software sub-module for acquiring specific parameters representative of the socio-professional profile associated with the behavioral model of each consumer agent.

15. System according to one of claims 13 or 14, characterized in that said display means comprise at least the display of a screen page for the entry of said specific parameters representative of the socio-professional profile of the behavioral model of each consumer agent, said screen page comprising a plurality of entry fields at least relating to:
age;
income;
social mobility.

16. System according to one of claims 13 to 15, characterized in that said display means at least comprise:
the display of a reference screen page comprising, in the active display zone of this screen page, an analog representation of consumer agent behavioral primitives such as imitation, innovation, conditioning, distrust and opportunism, each display zone of one of said analog representations corresponding to a zone of distribution of the decisional variables of imitation, innovation, conditioning, distrust and opportunism, the dominant decisional variable corresponding to the display zone of the analog representation associated with the corresponding distribution zone;
the display of a segmentation screen page in the form of behavioral tendencies, said screen page comprising a plurality of distribution zones, each distribution zone being representative of a dominant decisional variable associated with a behavioral primitive for all of the consumer agent models.
